(19) United States
(12) Patent Application Publication
(10) Pub. No.: US 2014/0101544 A1
(43) Pub. Date: Apr. 10, 2014

(54) DISPLAYING INFORMATION ACCORDING TO SELECTED ENTITY TYPE

(71) Applicant: MICROSOFT CORPORATION, Redmond, WA (US)

(72) Inventors: Brian Albrecht, Kirkland, WA (US); Julianne M. Bryant, Seattle, WA (US); Christopher Doan, Seattle, WA (US); Jeffrey Weir, Seattle, WA (US)

(73) Assignee: Microsoft Corporation, Redmond, WA (US)

(21) Appl. No.: 13/646,751

(22) Filed: Oct. 8, 2012

(51) Int. Cl. G06F 17/21

(52) U.S. Cl. 715/273

(57) ABSTRACT

User input identifying a selection of a textual portion of a document being displayed in a computer display region can be received. Identification of an entity indicated by the selection and text around the selection can be automatically requested. A determination of whether the identified entity is an entity type in a predetermined set of entity types can also be requested. Each entity type in the set can correspond to a display technique for displaying information about that entity type. The display technique for each entity type can be different and can include displaying one or more user interface items specific to the entity type. If the entity type is determined to be an entity type of the types in the set, then the information about the identified entity can be displayed according to the display technique for the determined entity type.

### BACKGROUND

Computing devices such as tablet devices, smart phones, laptop computers, and desktop computers are often used to view textual information. For example, such devices may be used to view Web pages, digital books in electronic reader (e-reader) applications, word processing documents, spreadsheets, presentation slides, or other types of documents.

### SUMMARY

It has been found that while reading text displayed on a computing device, users can find it advantageous to view information about a textual entity (a unit of text such as a word or phrase) related to the displayed text. Such information can provide insights into what is being read. Accordingly, it can be useful to allow a user to make a selection from the displayed text on the computing device, and for the computing device to respond by automatically displaying context-sensitive information about the selection. One or more embodiments discussed herein relate to such a responsive display of context-sensitive information.

In one embodiment, the tools and techniques can include receiving user input identifying a selection of a textual portion of a document being displayed in a computer display region. The technique can also include automatically requesting identification of an entity indicated by the selection and text around the selection. The technique can also include requesting a determination of whether the identified entity is an entity type in a predetermined set of entity types. Each entity type in the set can correspond to a display technique for displaying information about that entity type. The display technique for each entity type can be different and can include displaying one or more user interface items specific to the entity type. If the entity type is determined to be an entity type of the types in the set, then the technique can include displaying the information about the identified entity according to the display technique for the determined entity type.

In another embodiment of the tools and techniques, user input identifying a selection of text displayed in a computer display region can be received. An entity indicated by the selection and text around the selection can be automatically identified. Also, it can be automatically determined whether the identified entity is a first entity type in a predetermined set of entity types. It can also be determined whether the identified entity is a second entity type in a predetermined set of entity types. If the entity is determined to be the first entity type, then information about the identified entity can be displayed according to a first display technique that is specific to the first entity type. If the entity is determined to be the second entity type, then information about the identified entity can be displayed according to a second display technique that is specific to the second entity type. The second display technique can be different from the first display technique.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a schematic diagram of a context-sensitive information display environment.

FIG. 3 is a schematic diagram of a software system for automatic entity identification and disambiguation.

FIG. 4 is a flowchart of a method for providing disambiguation output for an ambiguous surface form.

FIG. 5 is an illustration of a computing device displaying a user interface for an electronic reader (e-reader) application.

FIG. 6 is an illustration of the computing device of FIG. 5 with a textual selection and a taskbar being displayed.

FIG. 7 is an illustration of the computing device of FIG. 5 showing an example of a textual selection in a main display region and representations of information about an identified meaning of the selection in a secondary display region.

FIG. 8 is an illustration of the computing device of FIG. 5 showing another example of a textual selection in a main display region and representations of information about an identified meaning of the selection in a secondary display region.

FIG. 9 is an illustration of the computing device of FIG. 5 showing another example of a textual selection in a main display region and representations of information about an identified meaning of the selection in a secondary display region.

FIG. 10 is an illustration of the computing device of FIG. 5 showing another example of a textual selection in a main display region and representations of information about an identified meaning of the selection in a secondary display region.

FIG. 11 is a flowchart of a context-sensitive information display technique.

FIG. 12 is a flowchart of another context-sensitive information display technique.

FIG. 13 is a flowchart of yet another context-sensitive information display technique.

### DETAILED DESCRIPTION

Embodiments described herein are directed to techniques and tools for improved display of context-sensitive information. Such improvements may result from the use of various techniques and tools separately or in combination.

Such techniques and tools may include identifying a meaning of a user selection of displayed text by analyzing textual context information around the selection. For example, identifying such a meaning may include entity identification, which can include identifying an entity that is indicated by the selection. As an example, if a user selects the letters “Ama” in “The Amazon is host to many tiny worms . . . ” in a document, the entity identification may identify “Ama” as the entity indicated by the selection, or it may identify “Amazon” as the entity indicated by the selection. Identifying a meaning may include disambiguation, which can include determining which of multiple possible meanings for the identified entity are indicated by surrounding textual context. Or stated another way, disambiguation can determine which of multiple possible entities are indicated by the surrounding textual context. For example, the “Amazon” entity may refer to the Amazon rainforest, the Amazon River, the Amazon people, the company named Amazon, etc. Additionally, if the disambiguation technique determines that the entity here refers to an entity for the Amazon rainforest, possible meanings or sub-entities could be the history of the Amazon rainforest, geography of the Amazon rainforest, people of the Amazon rainforest, travel to the Amazon rainforest, ecology of the Amazon rainforest, etc. Disambiguation can determine which of such possible meanings is indicated by surrounding context, according to a prescribed technique, as will be discussed more below. For example, the disambiguation may indicate that ecology of the Amazon rainforest is the identified meaning for the “Ama” selection discussed above such as by indicating a meaning in the form of an entity such as “Ecology of the Amazon Rainforest”.

The tools and techniques can also include retrieving and displaying information about the identified meaning for the selection. Information about the identified meaning may be retrieved and a representation of the retrieved information can be displayed along with the textual selection. For example, the textual selection may be displayed in one region of a user interface for an application (e.g., an e-reader application), and the representation of the retrieved information can be displayed in another region of a user interface for an application. For example, the textual selection may be displayed in a main display region of the user interface, and the representation of the retrieved information can be displayed in a secondary display region of the user interface.

The representation of the retrieved information can be formatted in any of various different ways and may include any of various different types of information. For example, the retrieved information may be a dataset and the representation may be a visualization of the dataset, where a format of the visualization is selected by analyzing the dataset. Other examples of representations can include digital articles such as encyclopedia articles, interactive or static maps, other interactive controls, Web search results, etc.

The tools and techniques can include selecting a display technique based on what type of entity is identified. The type of entity may be determined using text that is located around the selection. The text around the selection may or may not be located within a predetermined proximity to the selection. For example, the text around the selection may be text in the same user interface element (e.g., the same user interface dialog) as the selection, text in the same sentence as the selection, text in the same paragraph as the selection, text within a certain number of words as the selection, text in the same document as the selection, and/or other text connected to a document or user interface element where the selection is located (e.g., metadata for the document or user interface element). Different display techniques may display different types of representations (different types of user interface controls, etc.), retrieve information differently such as from different sources, format displayed representations differently, etc. For example, for the Amazon rainforest, one type of display technique for travel-type entities may include retrieving information on flights to airports in and around the Amazon rainforest and tourist information related to the Amazon rainforest. Such information can be displayed, including user interface controls to book flights and hotels, etc. In contrast, another type of display technique for historical entities may retrieve information for a timeline, as well as information for an article on history. For the history of the Amazon rainforest, for example, the display can include displaying the timeline as well as the historical article (or at least a portion of such an article, with the rest of the article being accessible by scrolling, etc.). As another example, for current dates (such as dates in the future and/or dates in the very recent past, another type of display technique may retrieve and display a user calendar.

Accordingly, one or more substantial benefits can be realized from the tools and techniques described herein. For example, users may be able to gain insights into selected portions of text being read, learn more about a topic indicated by selected portions of text, make a decision related to one or more selected portions of text, etc. This may be done in an automated context-sensitive manner to provide the user with relevant information on a selection, possibly in a manner that is convenient for the user.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

Techniques described herein may be used with one or more of the systems described herein and/or with one or more other systems. For example, the various procedures described herein may be implemented with hardware or software, or a combination of both. For example, dedicated hardware logic components can be constructed to implement at least a portion of one or more of the techniques described herein. For example and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various embodiments can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

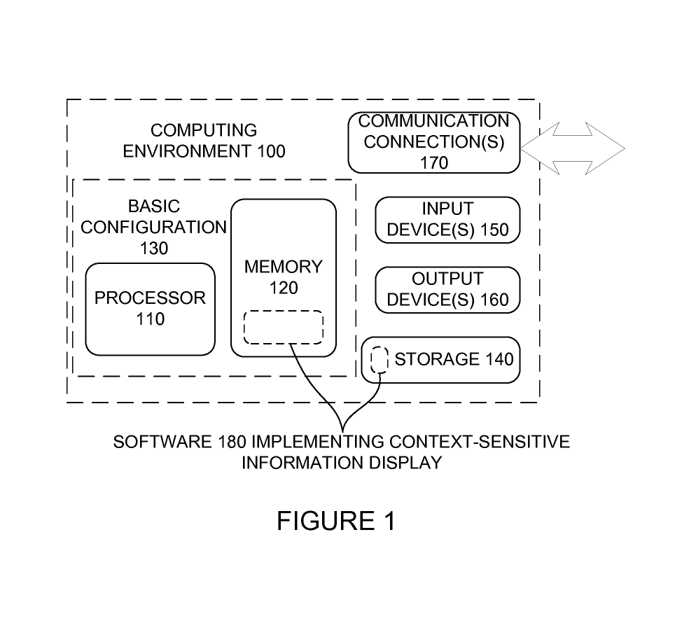

FIG. 1 illustrates a generalized example of a suitable computing environment (100) in which one or more of the described embodiments may be implemented. For example, one or more such computing environments can be used as a client computing environment and/or an information service computing environment. Generally, various different general purpose or special purpose computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit or processor (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing context-sensitive information display. An implementation of context-sensitive information display may involve all or part of the activities of the processor (110) and memory (120) being embodied in hardware logic as an alternative to or in addition to the software (180).

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as flash drives, magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be one or more of various different input devices. For example, the input device(s) (150) may include a user device such as a mouse, keyboard, trackball, etc. The input device(s) (150) may implement one or more natural user interface techniques, such as speech recognition, touch and stylus recognition, recognition of gestures in contact with the input device(s) (150) and adjacent to the input device(s) (150), recognition of air gestures, head and eye tracking, voice and speech recognition, sensing user brain activity (e.g., using EEG and related methods), and machine intelligence (e.g., using machine intelligence to understand user intentions and goals). As other examples, the input device(s) (150) may include a scanning device; a network adapter; a CD/DVD reader; or another device that provides input to the computing environment (100). The output device(s) (160) may be a display, printer, speaker, CD/DVD-writer, network adapter, or another device that provides output from the computing environment (100). The input device(s) (150) and output device(s) (160) may be incorporated in a single system or device, such as a touch screen or a virtual reality system.

The communication connection(s) (170) enable communication over a communication medium to another computing entity. Additionally, functionality of the components of the computing environment (100) may be implemented in a single computing machine or in multiple computing machines that are able to communicate over communication connections. Thus, the computing environment (100) may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “receive,” “identify,” “display,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Context-Sensitive Information Display System and Environment

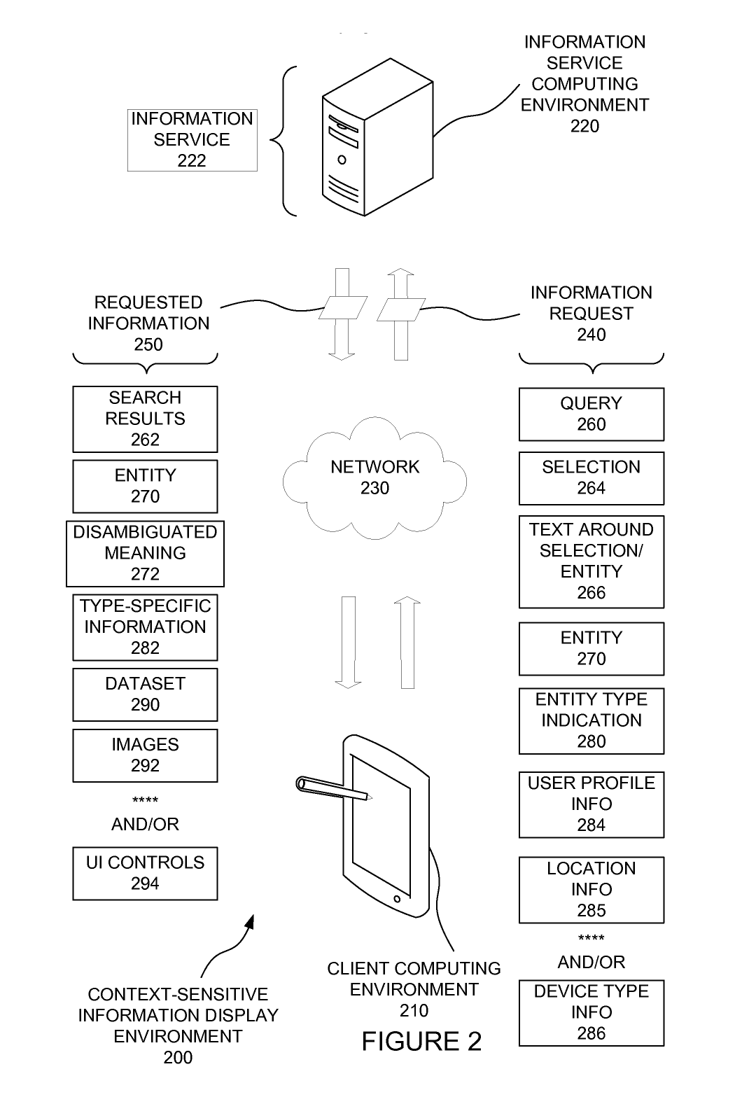

FIG. 2 is a block diagram of a context-sensitive information display system or environment (200) in conjunction with which one or more of the described embodiments may be implemented. The environment (200) can include a client computing environment (210) (which may or may not be connected to a server) that can receive user input and display text and other representations of information. The client computing environment (210) can communicate with an information service computing environment (220), which can include an information service (222). For example, the client computing environment (210) can communicate with the information service computing environment (220) over a computer network (230), such as a global computer network, a local area network, a wide area network, etc. Although the information service (222) is illustrated as being hosted in the information service computing environment (220), the information service (222) can be hosted in a single computing environment or distributed over multiple computing environments. For example, the information service (222) may include several different services, such as databases, search engines, entity identification services, disambiguation services, and/or other services. Additionally, one or more display and/or retrieval techniques used in the display environment (200) may be defined by different persons or associations than the ones operating the display environment (200), and those techniques may be incorporated into the display environment (200), such as by using software plugins. For example, different persons or associations may provide software plugins for display techniques for different types of named entities. The information service (222) can be a local and/or remote service, which may be located entirely or partially within the client computing environment (210).

The client computing environment (210) can send an information request (240) to the information service (222), and the information service (222) can respond with the requested information (250). For example, the client computing environment (210) can provide the information service (222) with a query (260), and the information service (222) can respond with search results (262). As another example, the client computing environment (210) can provide the information service (222) with a selection (264) and text (266) from around the selection (264), and the information service (222) can perform entity identification and respond with an identified entity (270) and/or with a disambiguated meaning (272) for the selection. As yet another example, the client computing environment (210) can provide the information service (222) with an identified entity (270) (e.g., where the client computing environment (210) performed entity identification) and with text (266) around the selection, and the information service (222) can respond with a disambiguated meaning (272) for the identified entity (270). As another example, the client computing environment (210) can provide the information service (222) with an identified entity (270) (e.g., a restaurant name and address) and an indication (280) of the type of entity (e.g., an indication that the entity is a restaurant), and the information service (222) can respond with type-specific information (282) (e.g., information that is specific to restaurants, such as a location map, a menu, restaurant reviews, hours of operation, etc.). As another example, the client computing environment (210) may provide the information service (222) with a selection (264) and text around the selection (266), and the information service (222) may respond by performing entity identification and disambiguation, constructing a query, running the query, and returning search results to the client computing environment (210). The information requests (240) may also include user profile information (284), which could be used to provide requested information (250) such as calendar information that is specific to the user profile; location information (285), which could be used to provide requested information (250) such as maps that are specific to a location such as a current location of the client computing environment (210); and/or device type information (286) such as information on a type of device being used for the client computing environment (210), which could be used to provide requested information (250) that is formatted for an indicated type of device (e.g., for a mobile telephone, for a tablet computer, etc.). Other types of information requests (240) and/or requested information (250) may be sent. For example, requested information (250) can include a dataset (290), images (292) such as maps (e.g., a map showing a location of a physical location from the address in the selection by itself, or a map showing a physical location of a physical address from the selection in relation to some other physical location such as a physical location of the client computing environment (210) at the time of the selection) or photographs, and/or user interface elements such as user interface controls (294).

### III. Entity Identification and Disambiguation

As noted, entity identification and disambiguation may be performed at the client computing environment (210) and/or the information service computing environment (220). Examples of techniques for performing entity identification and disambiguation will now be discussed.

A. Software System for Automatic Entity Identification and Disambiguation

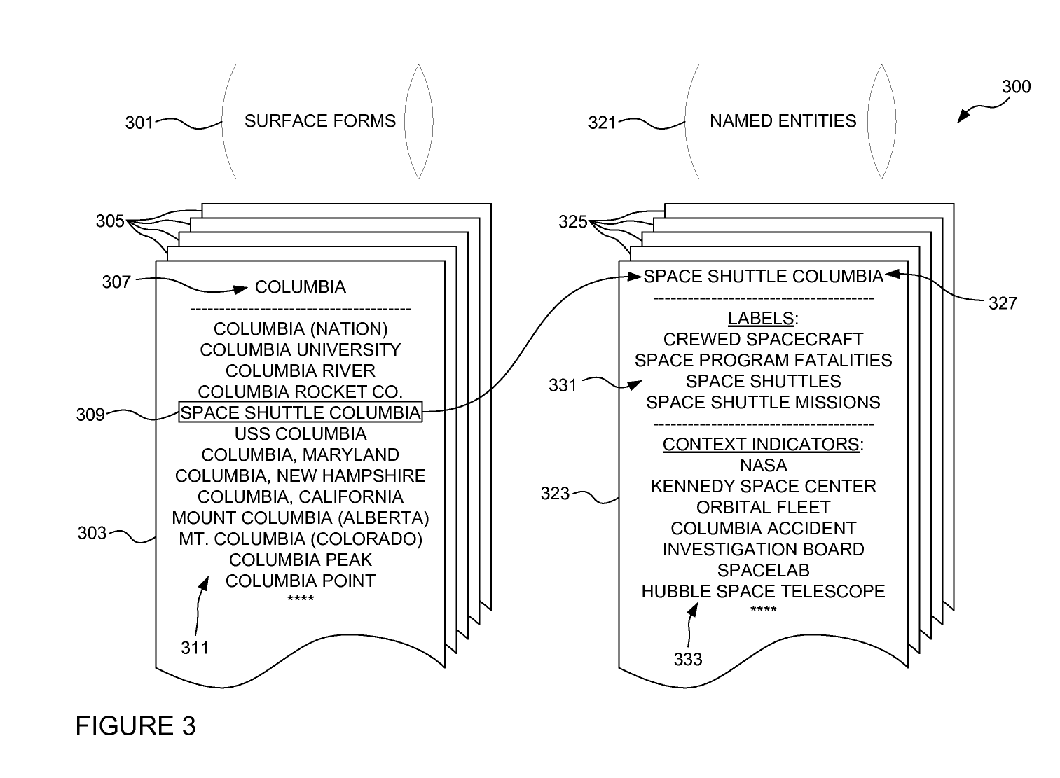

FIG. 3 depicts a block diagram for a software system (300) for automatic entity identification and disambiguation, according to an example. For example, software system (300) may include one or more databases and other software stored on a computer-readable medium. These may include, for example, a surface form reference database (301) with a collection of reference surface form records (303, 305); and a named entity reference database (321) with a collection of reference named entity records (323, 325), in this example. The surface form reference database (301) contains different surface forms, which are alternative words or multi-word terms that may be used to represent particular entities. Each of the reference surface form records (303, 305) is indexed with one or more named entities (311) associated with one or more of the reference named entity records (323, 325). Each of the reference named entity records (323, 325) is in turn associated with one or more entity indicators, which may include labels (331) and/or context indicators (333) in this embodiment. The labels (331) and context indicators (333) may be extracted from one or more reference works or other types of information resources, in which the labels (331) and context indicators (333) are associated with the named entity records (323, 325). Various tools and techniques may make use only of labels as entity indicators, or only of context indicators as entity indicators, or both. Various tools and techniques are also not limited to labels and context indicators as entity indicators, and may also use additional types of entity indicators, in any combination.

The software system (300) may be able to disambiguate a surface form with more than one meaning and associate an entity to the surface form, from among different named entities, such as persons, places, institutions, specific objects or events, or entities otherwise referred to with proper names. Named entities are often referred to with a variety of surface forms, which may for example be made up of abbreviated, alternative, and casual ways of referring to the named entities. One surface form may also refer to very different entities. For example, different instances of the surface form “Java” may be annotated with different entity disambiguations, to refer to “Java (island)”, “Java (programming language)”, “Java (coffee)”, etc., in one exemplary embodiment. A user interested in gaining information about the island of Java may therefore be able to reliably and easily hone in on only those references that actually refer to the island of Java, in this example.

In the example of FIG. 3, reference surface form record (303) is for the surface form “Columbia”, as indicated at the record's title (307). The surface form “Columbia” is associated in reference surface form record (303) with a variety of named entities that might be referred to by the surface form “Columbia”, an illustrative sample of which are depicted in FIG. 3. These include “Colombia (nation)”, which has a minor difference in spelling but often an identical pronunciation to the surface form corresponding to the record's title (307); Columbia University; the Columbia River; a hypothetical company called the Columbia Rocket Company; the Space Shuttle Columbia; the USS Columbia; and a variety of other named entities. The variation in spelling between “Columbia” and “Colombia” is another example of different surface forms that may represent the same named entity; for example, a Web search for “Bogota Columbia” may return a large fraction, such as about one-third, as many search results as a Web search for “Bogota Colombia”.

Reference named entity record (323) illustrates one example of a reference named entity in named entity reference database (321) that may be pointed to by a named entity (309) of the named entities (311) associated with reference surface form record (303). The reference named entity record (323) is for the named entity (327), “Space Shuttle Columbia”, and is associated with a variety of entity indicators. The entity indicators include labels (331) and context indicators (333), in this illustration. The labels (331) illustratively include “crewed spacecraft”, “space program fatalities”, “space shuttles”, and “space shuttle missions”, while the context indicators (333) illustratively include “NASA”, “Kennedy Space Center”, “orbital fleet”, “Columbia Accident Investigation Board”, “Spacelab”, and “Hubble Service Mission”, in the embodiment of FIG. 3. The labels (331) and context indicators (333) are used as bases for comparison with a text in which an ambiguous surface form appears, to evaluate what named entity is intended by the surface form, and are explained in additional detail below. The particular labels (331) and context indicators (333) depicted in FIG. 1 are provided only as illustrative examples, while any other appropriate entity indicators might be associated with the reference named entity “Space Shuttle Columbia”, and any of a variety of other named entities may be associated with the surface form “Columbia”. Additionally, other reference surface forms may also be used, with their associated named entities, and with the appropriate entity indicators associated with those reference named entities. This and the other particular surface forms and named entities depicted in FIG. 3 are illustrative only, and any other reference to a named entity in any kind of text, including a language input in another form of media that is converted into text, may be acted on by a disambiguation system to provide disambiguation outputs for polysemic surface forms.

B. Procedure for Automatic Entity Identification and Disambiguation

A procedure or method for entity identification and disambiguation can include two high-level portions: a procedure for preparing an automatic identification and disambiguation system, and a procedure for applying the automatic identification and disambiguation system.

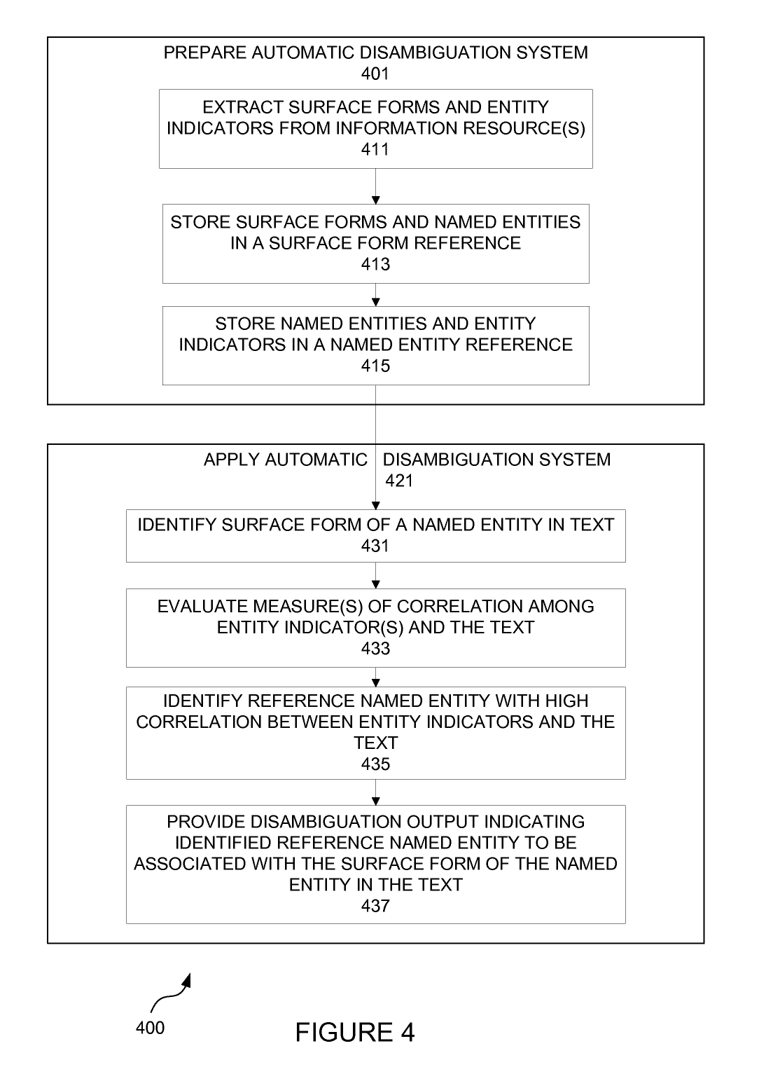

As an example, FIG. 4 depicts a method (400) for providing a disambiguation output for an ambiguous surface form, in one illustrative example. The method (400) can include two high-level portions, in this embodiment: a procedure (401) for preparing an automatic disambiguation system, and a procedure (421) for applying the automatic disambiguation system. The procedure (401) may illustratively include assembling the reference surface forms, associated reference named entities, and associated entity indicators of the software system (300) in FIG. 3, for example. The procedure (421) may illustratively include using the software system (300) in the process of providing disambiguation outputs in response to a user selecting all or a portion of ambiguous reference forms in displayed text.

According to the illustrative embodiment of FIG. 4, the procedure (401) illustratively includes step (411), of extracting a set of surface forms and entity indicators associated with a plurality of named entities from one or more information resources. Procedure (401) may further include step (413), of storing the surface forms and named entities in a surface form reference, comprising a data collection of surface form records indexed by the surface forms and indicating the named entities associated with each of the surface forms. Procedure (401) may also include step (415), of storing the named entities and entity indicators in a named entity reference, comprising a data collection of named entity records indexed by the named entities and containing the entity indicators associated with each of the named entities.

The procedure (421) can include a step (431), of identifying a surface form of a named entity in a text, wherein the surface form is associated in a surface form reference with one or more reference named entities, and each of the reference named entities is associated in a named entity reference with one or more entity indicators.

The procedure (421) can further include a step (433) of evaluating one or more measures of correlation among one or more of the entity indicators, and the text; a step (435) of identifying one of the reference named entities for which the associated entity indicators have a relatively high correlation to the text, where a correlation may be relatively high if it is higher than a correlation with at least one alternative, for example; and a step (437) of providing a disambiguation output that indicates the identified reference named entity to be associated with the surface form of the named entity in the text. The step (433) may include using labels alone, context indicators alone, both labels and context indicators, other entity indicators, or any combination of the above, as the entity indicators used for evaluating correlation. The disambiguation process can therefore use the data associated with the known surface forms identified in the information resource, and any of a wide variety of possible entity disambiguations in the information resource, to promote the capacity for automatic indications of high correlation between information from a text that mentions a surface form of a named entity, and the labels and context indicators stored in a named entity reference for that named entity, so that the reference to it in the document may be easily, automatically, reliably disambiguated.

Different embodiments may use different particular steps for any part of procedure (401), and are not limited to the particular examples provided in connection with FIG. 4. The illustrative steps depicted in FIG. 4 are elaborated on below.

1. Disambiguation System Preparation

Referring again to step (411), the information resources used for extracting the reference surface forms and entity indicators associated with named entities, may include a variety of reference sources, such as an electronic encyclopedia, a web publication, a website or related group of websites, a directory, an atlas, or a citation index, for example. Different embodiments may use any combination of these information resources, and are not limited to these examples, but may also include any other type of information resource.

For example, in one illustrative embodiment, an electronic encyclopedia may be used as an information resource from which to extract the information referred to in method (400). The electronic encyclopedia may be distributed and accessed on a local storage device, such as a DVD, a set of CDs, a hard drive, a flash memory chip, or any other type of memory device, or it may be distributed and accessed over a network connection, such as over the Internet, or a wide area network, for example. In another embodiment, the information resource may include a website, such as that of a large news organization, library, university, government department, academic society, or research database. In another embodiment, the information resource may include a large research citation website or a website for uploading drafts of research papers, for example. In other embodiments, the information resource may include a selected set of websites, such as a group of science-oriented government websites that includes the content of the websites for NASA, the NOAA, the Department of Energy, the Centers for Disease Control and Prevention, and the National Institutes of Health, for example. Other embodiments are not limited to these illustrative examples, but may include any other type of information resource from which the appropriate information may be extracted.

In one illustrative embodiment, an electronic encyclopedia may include various encyclopedia entries, articles, or other documents about a variety of different named entities that include “Colombia”, “Columbia University”, “Columbia River”, “Space Shuttle Columbia”, and so forth. The names for these named entities may serve as the titles for the articles in the encyclopedia. As procedure (401) of preparing the automatic disambiguation system is being performed, the information is extracted from the article entitled “Colombia (nation)”, including an indication that it is sometimes referred to under the spelling “Columbia”. A reference named entity record entitled “Colombia” is created in the named entity reference database (321), and the reference named entity “Colombia (nation)”, associated with the reference named entity, is added to a reference surface form record for the surface form “Columbia” in a surface form reference database (301). Similarly, information is extracted from a document about “Columbia University” in the electronic encyclopedia to create a reference named entity record for “Columbia University”, with the reference named entity added to the record for reference surface form “Columbia”, information is extracted from an entry in the electronic encyclopedia entitled “Space Shuttle Columbia” to add the corresponding reference named entity record in the named entity reference database and an associated addition to the record for reference surface form “Columbia”, and so forth. The different steps (411 and 413) may be repeated iteratively for each document or other information resource from which information such as surface forms and entity indicators are extracted, or information from several documents may be extracted and then stored together, for example; the different aspects of procedure (401) may be performed in any order.

Each of the named entities extracted from an information resource may be stored with associations to several surface forms. For example, the title of an article or other document may be extracted as a surface form for the named entity to which it is directed. A named entity may often be referred to by a surface form that unambiguously identifies it, and may have a document in the information resource that is entitled with that unambiguous name. The title of an encyclopedia article may also have a distinguishing characteristic added to the title, to keep the nature of the document free from ambiguity. For example, an article in an electronic encyclopedia on the U.S. state of Georgia may be entitled “Georgia (U.S. state)”, while another article may be entitled “Georgia (country)”. Both of these may be extracted as named entities, with both of them associated with the surface form “Georgia”.

Information for the entity indicators may be collected at the same time as for surface forms. In this case, for example, the other information in these document titles could be stored among the labels (331) for the respective reference named entity records, so that the reference named entity record on “Georgia (U.S. state)” includes the label “U.S. state” and the reference named entity record on “Georgia (country)” includes the label “country”. Accordingly, the labels can indicate the type of entity being discussed. As discussed below, such type information can be used to choose an appropriate display technique for that type of entity. The labels may constitute classifying identifiers applied to the respective named entities in the encyclopedia or other information source.

An electronic encyclopedia may also include documents such as a redirect entry or a disambiguation entry. For example, it may have a redirect entry for “NYC” so that if a user enters the term “New York City” in a lookup field, the “NYC” redirect page automatically redirects the user to an article on New York City. This information could therefore be extracted to provide a reference named entity record for New York City with an associated surface form of “NYC”. Similarly, the surface form “Washington” and an associated context indicator of “D.C.” can be extracted from a document entitled “Washington, D.C.” Context indicators are discussed further below.

Another feature an electronic encyclopedia may use is a disambiguation page. For example, the encyclopedia may have a disambiguation page for the term “Washington” that appears if someone enters just the term “Washington” in a lookup field. The disambiguation page may provide a list of different options that the ambiguous term may refer to, with links to the specific documents about each of the specific named entities, which may include “Washington, D.C.”, “Washington (U.S. state)”, “George Washington”, and so forth. Information could therefore be extracted from this disambiguation page of the information resource for reference named entity records for each of the specific named entities listed, with a surface form of “Washington” recorded for each of them, and with context indicators extracted for each of the named entities based on the elaboration on the term “Washington” used to distinguish the different documents linked to on the disambiguation page.

Various other sources may also be used for extracting label and context information for the reference named entity records. For example, different entries in the electronic encyclopedia may include category indicator tags, and the encyclopedia may include a separate page for a category, showing all the entries that are included in that category. For example, the entries for “Florida” and “Georgia (U.S. state)” may both include category tags labeled “Category: U.S. States”. The encyclopedia may also include separate pages for lists, such as a page entitled, “List of the states in the United States of America”, with each entry on the list linked to the individual encyclopedia entry for that state.

Labels are not limited to the particular examples discussed above, such as title information, categories and other types of tags, and list headings, but may also include section names or sub-headings within another article, or a variety of other analogous labeling information.

Context indicators are other types of entity indicators that may be extracted from an electronic encyclopedia or other information resource and applied to respective named entities, either alone or together with labels, among other combinations, in different embodiments. Context indicators may include attributes such as elements of text associated with their respective named entities, by means of an association such as proximity in the title of an article in an encyclopedia or other type of information resource, proximity to the name of the named entity in the text of an entry or article, or inclusion in a link to or from another entry directed to another named entity in the information resource, for example. As examples of linking context indicators, an article about the Space Shuttle Columbia may include a reference to its serving mission to the Hubble Space Telescope, with the phrase “Hubble Space Telescope” linked to an article on the same; while another article on the Kennedy Space Center may include a reference to the “Space Shuttle Columbia” with a link to that article. The titles of articles linking both to and from the article on the space shuttle Columbia may be extracted as context indicators in the named entity reference record for “Space Shuttle Columbia”. Other types of context indicators may also be used, that are not limited to these illustrative examples.

Context indicators and labels may both provide valuable indicators of what particular named entity is intended with a given surface form. For example, the electronic encyclopedia may include an article that contains both the surface forms “Discovery” and “Columbia”. Their inclusion in the same article, or their proximity to each other within the article, may be taken as a context indicator of related content, so that each term is recorded as a context indicator associated with the named entity reference of the other term, under the specific named entity reference records for “Space Shuttle Discovery” and “Space Shuttle Columbia” in the named entity reference database. Additionally, both terms may appear in an article entitled “Space shuttles”, and they both may link to several other articles that have a high rate of linking with each other, and with links to and from the article entitled “Space shuttles”. These different aspects may be translated into context indicators recorded in the named entity references, such as a context indicator for the term “space shuttle” in both of the named entity reference records. It may also be used to weight the context indicators, such as by giving greater weight to context indicators with a relatively higher number of other articles that also have links in common with both the named entity and the entity indicator.

Weighting the relevance of different entity indicators may also take the form of weighting some entity indicators at zero. This may be the case if very large amounts of potential entity indicators are available, and certain criteria are used to screen out identity indicators that are predicted to be less relevant. For example, context indicators may be extracted and recorded to a named entity reference record only if they are involved in an article linked from the article for the named entity that also links back to the article for the named entity, or if the article for a candidate context indicator shares a threshold number of additional articles to which it and the article for the named entity share mutual links. Techniques such as these can effectively filter candidate context indicators to keep unhelpful indicators out of the named entity reference record.

Additionally, both the “Space Shuttle Discovery” and “Space Shuttle Columbia” articles in the electronic encyclopedia may include category tags for “Category: Crewed Spacecraft” and “Category: Space Shuttles”. They may both also include a list tag for “List of Astronautical Topics”. These category and list tags and other potential tags may be extracted as labels for the named entity references for both named entities. The quantity of different labels and context indicators in common between the two named entity references could contribute to a measure of correlation or similarity between the two named entity references.

The disambiguation system preparation may include having different named entity databases (321) and/or different named entities (327) within the named entity database (321) for different languages and/or different dialects. For example, a United Kingdom English dialect may have a named entity for “boot,” meaning of an enclosed storage compartment of an automobile, usually at the rear. A United States English dialect may not have that named entity for “boot”, but the United States English dialect may have a named entity for a “trunk,” meaning of an enclosed storage compartment of an automobile, usually at the rear. The disambiguation system application, which is discussed in the following section, can include detecting a user's language and/or dialect (e.g., via system settings, preferences, a user profile, etc.). Then the appropriate set of named entities for the detected language/dialect can be used in the disambiguated system application discussed below.

2. Disambiguation System Application

Returning to procedure (421), with the automatic disambiguation system prepared by procedure (401), it can be ready to use to disambiguate named entities in a subject text. This subject text may be from a web browser, a fixed-layout document application, an email application, a word processing application, or any other application that deals with the presentation of text output. Text around a selection may be used in the procedure (421) for entity identification and disambiguation. The examples below will focus on the case where an entire document is used as the contextual text around the selection. However, the text to be used in the procedure (421) may include all the text in a document, the text in only a portion of the document around the selection, or some other text around the selection. A document or other portion of text around the selection may have already been processed to identify and tag terms in the document with indications of the disambiguated named entities referenced by those terms. For example, this may have been performed prior to a term being selected in response to user input. If the selected term has already been tagged to associate the term with a disambiguated named entity, then that disambiguated named entity may be used, possibly without going through the procedure (421) again for the selected term. The named entity can be associated with information on the type of entity (historical date, geographic location, etc.) and possibly additional terms (e.g., labels and/or context indicators) that could be used in retrieving and/or displaying additional information for that named entity (e.g., formulating search queries, etc.), as will be discussed more below.

Procedure (421) may include some pre-processing steps to facilitate identifying the surface forms of named entities. For example, the system may split a document into sentences and truecase the beginning of each sentence, hypothesizing whether the first word is part of an entity or it is capitalized because of orthographic conventions. It may also identify titles and hypothesize the correct case for words in the titles. Pre-processing may also include extracting named entities and associated labels and/or context indicators from the document itself. This could be done in a manner similar to how information is extracted from other sources, as discussed above. This extraction may be focused on terms that could originate from the document and/or a group of documents that includes the document. For example, the extraction may focus on fictional book characters, fictional locations in fictional works, etc., by determining whether the terms show high correlations to named entities extracted from other sources (very low correlations to named entities could make it more likely that a term is an entity unique or semi-unique to the document). Additionally, capitalized terms may be considered more likely to be fictional characters than non-capitalized terms. Also, documents may be categorized as fictional or non-fictional works (e.g., in response to user input when the document was created or at some later time, or by extracting such information from other sources such as available library databases), with fictional works being more likely to include fictional entities. Such fictional entities may be considered a different type of entity, and selection of the fictional entities may invoke different display techniques than other types of entities. For example, selection of a fictional character may result in the display of timeline of when the character appears throughout the book (or possibly a line illustrating page numbers or chapters when the character appears). Other information may also be shown that is related to a fictional entity. For example, if a fictional document provides a map, and a selected term is associated with an entity that is identified as a geographic location (e.g., by identifying the named entity as also appearing on a map in the document), then the map may be displayed. As another example, if the document is a fictional book, then other books by the same author (e.g., other books in a series) may be searched for the selected named entity and links may be provided to portions of the other books where the named entity appears.

In a second stage of pre-processing the text, a statistical named-entity recognizer may identify boundaries of mentions of the named entities in the text, and assign each set of mentions sharing the same surface form a probability distribution over named entity labels, such as Person, Location, Organization, and Miscellaneous.

In this illustrative embodiment, the named entity recognition component may also resolve structural ambiguity with regard to conjunctions (e.g., “The Ways and Means Committee”, “Lewis and Clark”), possessives (e.g., “Alice's Adventures in Wonderland”, “Britain's Tony Blair”), and prepositional attachment (e.g., “Whitney Museum of American Art”, “Whitney Museum in New York”) by using surface form information extracted from the information resource, when available, with back-off to co-occurrence counts on the Web. The back-off method can be applied recursively, as follows: for each ambiguous term T₀ of the form T₁ Particle T₂, where Particle is one of a possessive pronoun, a coordinative conjunction, or a preposition, optionally followed by a determiner, and the terms T₁ and T₂ are sequences of capitalized words and particles, a web search can be performed on the search query “T₁” “T₂”, which yields only search results in which the whole terms T₁ and T₂ appear. A collection of the top search results, for example the first two-hundred, may be evaluated to see how many also include the term T₀, as a test of whether T₀ is a reference to one single entity, or if T₁ and T₂ are two separate entities conjoined in context.

In a third stage of pre-processing the text, shorter or abbreviated surface forms may be resolved to longer forms. It is not uncommon for a named entity to be introduced in a document in a longer, formal version of the name of the entity, and for at least some subsequent mentions of the entity to be made with abbreviated or more casual surface forms. For example, a text may introduce a reference to the named entity “Franklin Delano Roosevelt”, and then make several subsequent references to the more abbreviated or casual surface forms, “Franklin Roosevelt”, “President Roosevelt”, “Roosevelt”, or simply “FDR”, though some subsequent references to the full name of the named entity may also be made. A regular pattern consistent with this usage in the threshold search results may be taken to indicate that a set of a longer named entity with component forms of the named entity is indeed a regular relationship between a named entity and surface forms of the named entity in the text. Therefore, before attempting to solve semantic ambiguity with subsequent steps of the procedure (421), the system may hypothesize in-document co-references and map short surface forms to longer surface forms with the same dominant label. For example, “Roosevelt”/PERSON can be mapped to “Franklin Delano Roosevelt”/PERSON.

This is only one illustrative example of pre-processing named references and surface forms in a document. Additional pre-processing steps, such as for resolving acronyms and expanding selections of partial words to whole words may also be resolved in a similar manner when possible. The system is not limited to any particular pre-processing steps or to performing any pre-processing steps, in other embodiments.

Such pre-processing stages may be followed by extracting the contextual and category information from the information resource to disambiguate the entities in the subject text, following the steps of the procedure (421). The procedure (421) may produce the disambiguation output in any of a variety of forms, and such disambiguation output can indicate the disambiguated meaning, and can be used in requesting information about that disambiguated meaning.

In one illustrative embodiment, an example of which will be discussed below, the disambiguation process may employ a vector space model, in which a vectorial representation of the processed document is compared with vectorial representations of the named entity references stored in the named entity database. Once the surface forms in a subject text are identified and the in-document co-references hypothesized, the system may retrieve possible entity disambiguations of each surface form. Their entity indicators, such as the labels and context indicators that occur in the document, may be aggregated into a document vector, which is subsequently compared with named entity vectors representing the named entity references of various possible entity disambiguations, so that one or more measures of correlation between the vectors representing surface forms in the text and the vectors representing the entity indicators may be evaluated. One of the reference named entities may then be identified for a particular surface form that maximizes the similarity between the document vector and the entity vectors. Or, in other embodiments, a reference named entity is identified that in some other way is found to have a high correlation to the surface form in the text, relative to other candidate named entities.

The illustrative example of maximizing the similarity of the vectors representing the surface form from the subject text, and the identified reference named entity, may be elaborated on as follows, in accordance with one illustrative embodiment. It may be well appreciated by those skilled in the art that a broad variety of other implementations may be analogous to or approximate to the illustrative implementation described here, within the scope of various embodiments; and furthermore that other embodiments may also be implemented with very substantial differences, that nevertheless accomplish the broad outlines of aspects of the present disclosure.

In this illustrative example, a vector space model may be used to evaluate measures of correlation or similarity between elements of a subject text and entity indicators. In this illustrative embodiment, formally, let C={c₁, . . . , c_{M}} be the set of known context indicators from the information resource, and T={t₁, . . . , t_{N}} be the set of known labels. An entity e can then be represented as a vector δₑε{0,1}^{M+N}, with two components, δₑ|_{c}ε{0,1}^{M} and δₑ|_{T}ε{0,1}^{N}, corresponding to the context information and category labels, respectively:

$${δ}_{e}^{i} = \{ \begin{matrix}1 , {if\_c}_{i} \_is \_a \_context \_indicator \_for \_entity \_e \\ 0 , otherwise\end{matrix} \\ {δ}_{e}^{M + i} = \{ \begin{matrix}1 , {if\_t}_{j} \_is \_a \_label \_for \_entity \_e \\ 0 , otherwise\end{matrix}$$

Let ε (s) denote the set of entities that are known to have a surface form s. For example, in FIG. 3, the named entities “Columbia University” and “Space Shuttle Columbia” are two named entities that both share a common surface form, in “Columbia”. Let D be a document or other set of contextual text to be analyzed and let S(D)={s₁, . . . , sₙ} be the set of surface forms identified in D. A context vector may be built as d={d₁, . . . , d_{M}}εN^{M}, where dᵢ is the number of occurrences of context indicators cᵢ in D. To account for all possible disambiguations of the surface forms in D, an extended vector may also be built as d̅εN^{M+N} so that d̅|_{c}=d and

$$d {\vert}_{T} = {\sum }_{s ∈ S ( D )}^{ } \text{?} {δ}_{e} {\vert}_{τ} \\ \text{?} \text{indicates text missing or illegible when filed}$$

The goal in this illustrative embodiment can be to find the assignment of entities to surface forms sᵢ [symbol] eᵢ,iε1 . . . n, that maximizes the agreement between δ_{δe′}|_{c}=d and d, as well as the agreement between the labels of any two entities δₑ_{ᵢ}|_{T} and δₑ_{ⱼ}|_{T}. For example, the document may contain both the surface forms “Discovery” and “Columbia”. On one hand, the disambiguations “Space Shuttle Discovery” and “Space Shuttle Columbia” would share a large number of category labels and thus, this assignment would result in a high agreement of their category components. On the other hand, the category components for the disambiguations “Space Shuttle Discovery” and “Colombia (country)” would not be likely to generate a significant measure of correlation/agreement between each other. This agreement maximization process is discussed in more detail further below. In another illustrative example, agreement between different context indicators may be evaluated to maximize the agreement or correlation with entity indicators in the text. One document that mentions “Columbia” may also include the text strings “NASA”, “Kennedy Space Center”, and “solid rocket booster”, leading to identification of the surface form “Columbia” with the named entity “Space Shuttle Columbia”. Another document that mentions “Columbia” may also include the text strings “Bogota”, “Cartagena”, and “Alvaro Uribe”, leading to identification of the surface form “Columbia” with the named entity “Colombia (nation)”.

The agreement maximization process can be written as the following Equation 1:

$$\text{?} {\sum }_{i = 1}^{n} < \text{?} {\vert}_{c} , d > + {\sum }_{i = 1}^{n} {\sum }_{{j = 1}_{j \neq 1}}^{n} < \text{?} {{\vert}_{τ} , {δ}_{ej} \vert}_{τ} > , \\ \text{?} \text{indicates text missing or illegible when filed} \qquad ( Eq . 1 )$$

where <.,.> denotes the scalar product of vectors.

One potential issue with Equation 1 is that an erroneous assignment of an entity to a surface form may interfere with the second term of Equation 1. This issue may be addressed with another strategy to account for category agreement, which reduces the impact of erroneous assignments in a computationally efficient manner, includes attempting to maximize agreement between the categories of the entity disambiguation of each surface form and the possible disambiguations of the other surface forms in the subject document or text. In one illustrative implementation, this may be equivalent to performing the following Equation 2:

$$\text{?} {\sum }_{i = 1}^{n} < \text{?} , \overline{d} - \text{?} {\vert}_{τ} > \\ \text{?} \text{indicates text missing or illegible when filed} \qquad ( Eq . 2 )$$

Using the definition of d̅ and partitioning the context and category components, the sum in Equation 2 can be rewritten as follows:

$${\sum }_{i = 1}^{n} < \text{?} {\vert}_{c} , d > + {\sum }_{i = 1}^{n} < \text{?} {\vert}_{τ} , \overline{d} {{\vert}_{τ} - \text{?} \vert}_{τ} >= \\ {\sum }_{i = 1}^{n} < \text{?} {\vert}_{c} , d > + {\sum }_{i = 1}^{n} < \text{?} {\vert}_{τ} , ( {\sum }_{j = 1}^{n} \text{?} {δ}_{e} ) - {δ}_{{e}_{i}} {\vert}_{τ} >= \\ {\sum }_{i = 1}^{n} < {δ}_{{e}_{i}} {\vert}_{c} , d > + {\sum }_{i = 1}^{n} {\sum }_{{j = 1}_{j \neq 1}}^{n} < {δ}_{{e}_{i}} {\vert}_{τ} , \text{?} {δ}_{e} > ( q . e . d . )$$

$$\text{?} \text{indicates text missing or illegible when filed}$$

In this implementation, the maximization of the sum in Equation 2 is equivalent to the maximization of each of its terms, which means that the computation reduces to the following:

$$\text{?} < {δ}_{{e}_{i}} , \\ \overline{d} - {δ}_{{e}_{i}} {\vert}_{τ} > , \\ i ∈ 1 … n , \\ \text{?} \text{indicates text missing or illegible when filed}$$

or equivalently,

$$\text{?} < {δ}_{{e}_{i}} , \overline{d} > - {‖ {δ}_{{e}_{i}} {\vert}_{τ} ‖}^{2} , i ∈ 1 … n \\ \text{?} \text{indicates text missing or illegible when filed} \qquad ( Eq . 3 )$$

The disambiguation process following this illustrative embodiment therefore may include two steps: first, it builds the extended document vector, and second, it maximizes the scalar products in Equation 3. In various embodiments, it is not necessary to build the document vector over all context indicators C, but only over the context indicators of the possible entity disambiguations of the surface forms in the document.

One illustrative embodiment may include normalizing the scalar products by the norms of the vectors, and thereby computing the cosine distance similarity. In another illustrative embodiment, following Equation 3, the scalar products are not normalized by the norms of the vectors, but rather, an implicit accounting is made for the frequency with which a surface form is used to mention various entities and for the importance of these entities, as indicated by entities that have longer articles in the information resource, that are mentioned more frequently in other articles, and that tend to have more category tags and other labels, according to an illustrative embodiment. A broad variety of other methods of evaluating the measures of similarity may be used in different embodiments, illustratively including Jensen-Shannon divergence, Kullback-Liebler divergence, mutual information, and a variety of other methods in other embodiments.

In some illustrative instances, one surface form can be used to mention two or more different entities within the same text or document. To account for such cases, the described disambiguation process may be performed iteratively in this embodiment for the surface forms that have two or more disambiguations with high similarity scores with the extended document vector. This may be done by iteratively shrinking the context used for the disambiguation of each instance of such a surface form from document level to paragraph level, and if necessary, to sentence level, for example. For example, in FIG. 2, the surface form “Columbia” appears twice, fairly close together, but intended to indicate two different named entities. The disambiguation data may be restricted to the sentence level in the immediate proximity of these two surface forms, or may concentrate the weightings assigned to entity indicators within the immediate sentence of the surface forms, in different embodiments. In one illustrative implementation, this would accord an overwhelming weight to entity indicators such as “NASA” for the first surface form of “Columbia”, while assigning overwhelming weight to entity indicators such as “master's degree” for the second surface form of “Columbia”, thereby enabling them to be successfully disambiguated into identifications with the named entities of the “Space Shuttle Columbia” and “Columbia University”, respectively, according to this illustrative embodiment.

As is discussed herein, a user may select a subset of text, and that selection can be evaluated as a surface form as discussed above. This may be done in the context of all or a portion of a document where the selection of text is located. For example, the entity identification and disambiguation may be performed considering the document where the selection is located, a paragraph where the selection is located, a sentence where the selection is located, a block of text that includes a predefined number of words (e.g., 25 words) before and after the selection, etc.

### IV. Use of Entity Recognition and Disambiguation Results

Examples of using results of entity recognition and disambiguation will now be discussed. In each of the examples, user input can be provided to make a selection of text for which additional information is desired. In response to such input, the entity recognition and disambiguation tools and techniques discussed above can be performed to recognize a meaning of the selection in the form of a disambiguation result (e.g., an entity selected as a result of disambiguation). The disambiguation result may include an indication of the type of entity. For example, this entity type may be indicated by the labels for the determined entity (e.g., “Joe's Taco Shack”\Restaurants, or “999-999-9999”\Telephone_Number). Such disambiguation results can be used to provide context-sensitive displays representing information about the text selected by user input. Some examples of this will now be discussed.

A. Displaying Context-Sensitive Information Along with Selected Text

An entity type identified using disambiguation may be used to request additional information about that entity type and in turn about the selection of text made by the user. This additional information (information in addition to the selection and in addition to the identified meaning such as an identified entity type) can be viewed along with the existing display from which the text was selected. For example, the existing text display and the display of additional information may be in different regions of a user interface for an application that is used to display the selected text. In one example, the additional information may be shown in a sidebar adjacent to a main display that is displaying the textual selection.

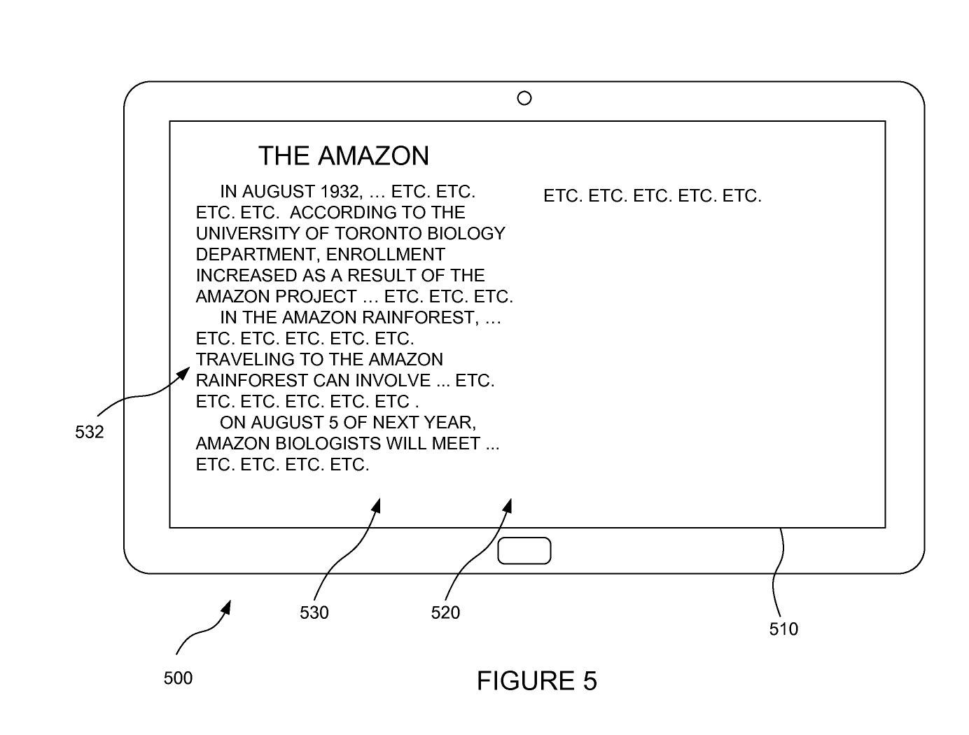

One example will be discussed with reference to FIGS. 5-7. It is noted that in FIGS. 5-10, the text and other illustrated information are for illustration purposes only, and are not represented to be factually accurate. FIG. 5 illustrates a computing device (500), such as a tablet computer, which can act as a client computing device with which a user can interact. The device of FIG. 5 includes a display (510), which can be a touch screen. The display is illustrated as displaying a full-screen user interface (520) for an e-reader application. However, the tools and techniques discussed herein could be used with other applications, or outside the context of applications, such as in a word processing application, a presentation slide application, a spreadsheet application, or in operating system features outside of applications running on an operating system. The user interface (520) includes a main display region (530) that is displaying text (532) from a digital document, such as a digital article.

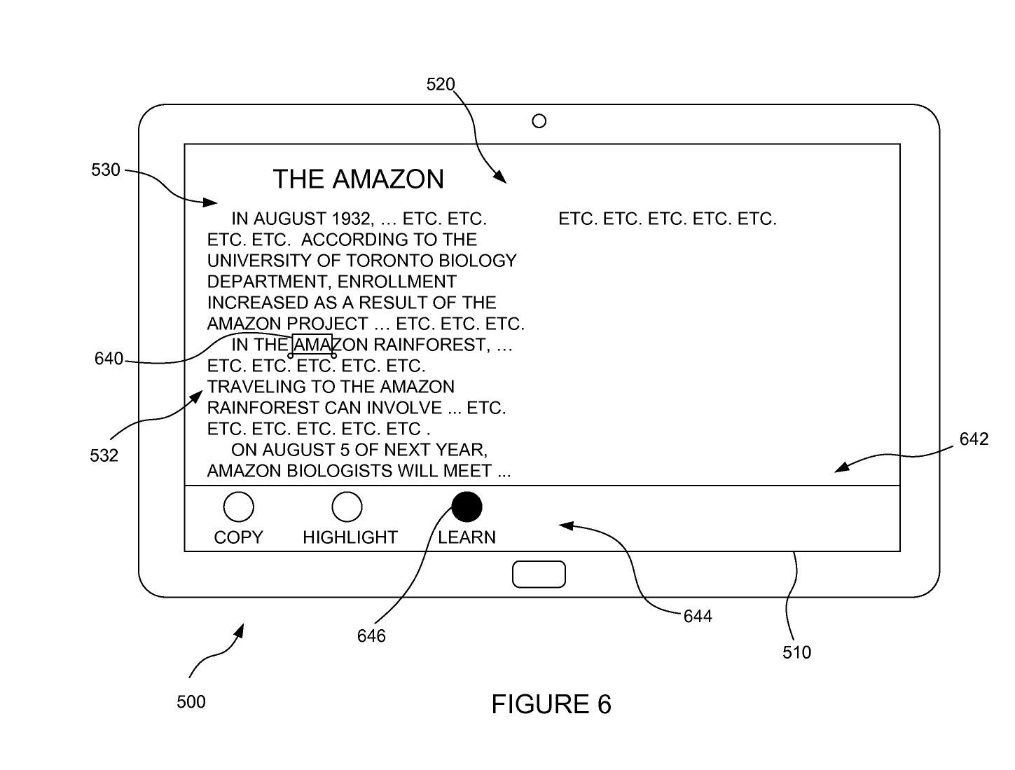

On the display (510), a user can provide user input to make a selection of a portion of the displayed text (532). For example, this may be done by using a touch screen, a mouse, a cursor control key, a touch pad, etc. As an example, referring to FIG. 6, a user may provide user input to make a selection (640) of the text “AMA” in the phrase “IN THE AMAZON RAINFOREST, . . . ” In response, the device (500) can surface a taskbar (642), such as at the bottom of the display (510). The taskbar (642) can include user interface controls (644) that can be selected to invoke features related to the selection (640). For example, the user controls (644) can include a control for copying the selection, a control for highlighting the selection, a control for making notes or comments about the selection, etc. Additionally, the taskbar (642) can include a control (646), labeled “LEARN” in the illustrated example, that can invoke the context-sensitive information display features discussed herein. Accordingly, the combined user input of indicating the selection (640) and selecting the “LEARN” control (646) can be the combined user input indicating that the selection (640) is to be the input selection for context-sensitive display actions, which can be automated in response to that selection. Alternatively, the indicated selection (640) may be made with a single action—for example, just by selecting the text of the selection (640) without making an additional selection of a user interface control. As another alternative, the indicated selection (640) may be made with additional user input actions, such as additional actions providing more specific direction for the context-sensitive information display.

In response to the combined user input indicating the selection (640), the device (500) can request that one or more services automatically identify a context-sensitive meaning of the selection by analyzing textual context information around the selection in the document. For example, this may be done by requesting one or more software and/or hardware services in the device (500) to perform one or more actions and/or by requesting that one or more remote software and/or hardware services perform one or more actions. Such actions can include performing entity recognition and disambiguation. For example, in entity identification, it can be determined that the selection of “AMA” was meant to refer to a surface form in the text (532) with larger boundaries than the selection itself, such as “AMAZON RAINFOREST”, which can be the recognized entity. However, there may be multiple possible meanings associated with the Amazon rainforest. Accordingly, the text around the selection (640) can be used in disambiguation to arrive at a meaning of “travel in the Amazon rainforest”.

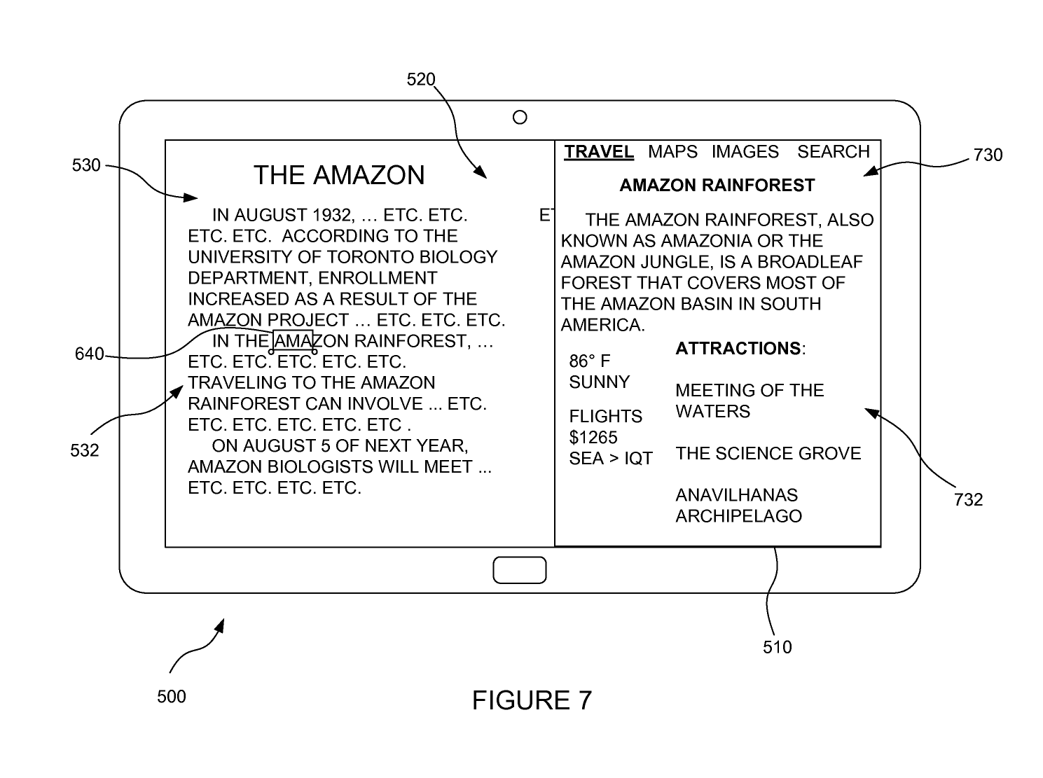

Referring to FIG. 7, the device (500) can automatically retrieve additional information about the identified meaning of the selection from a service, and can automatically adjust and arrange a secondary display region (730) of the user interface (520) alongside the main display region (530). The device (500) can also display one or more representations (732) of the information about the identified meaning in the secondary display region (730). For example, as illustrated, the information can include a brief description of the Amazon rainforest, an indication of current weather at some location in the Amazon rainforest, information about flights to the Amazon rainforest, and a listing of attractions in the Amazon rainforest. One or more of the representations (732) may also be a user interface control that can be selected by a user to find out more information about the topic indicated by the representation (732). For example, the text “86° F. SUNNY” may be selected by user input, and the device (500) can respond by retrieving and displaying more detailed information about the weather and climate in the Amazon rainforest. As another example, the text “FLIGHTS $1265 SEA>IQT” may be selected by user input, and the device (500) can respond by retrieving and surfacing information from a flight-booking service on the display (510). Additionally, links may be selected for additional features, such as maps, images, and search (e.g., a Web search). Each of these can result in the display of features that are tailored to the identified meaning. For example, the map can be a map of the Amazon rainforest and the map may highlight travel-related features. Additionally, the identified meaning can be used to construct a tailored query to be submitted to a service to retrieve travel-related images of the Amazon rainforest. As another example, the identified meaning can be used to construct a tailored query to be submitted to a search engine, such as a Web search engine to retrieve search results specific to traveling and the Amazon rainforest. As an alternative to surfacing the travel-tailored information in the representations (732), the device (500) could have automatically responded to the identification of the selection (640) by retrieving and displaying such a map, image search results, and/or Web search results, or other context-specific information.

For any such representations of context-sensitive information about a selection, the representation(s) of the information can be displayed in the secondary display (730) on the display (510) at the same time as the selection (640) and the other text around the selection continues to be displayed in the main display region (530). The display regions (530, 730) may be automatically adjusted in size and/or shape to allow for favorable viewing of both display regions (530, 730) at the same time.

B. Displaying Information According to Selected Entity Type

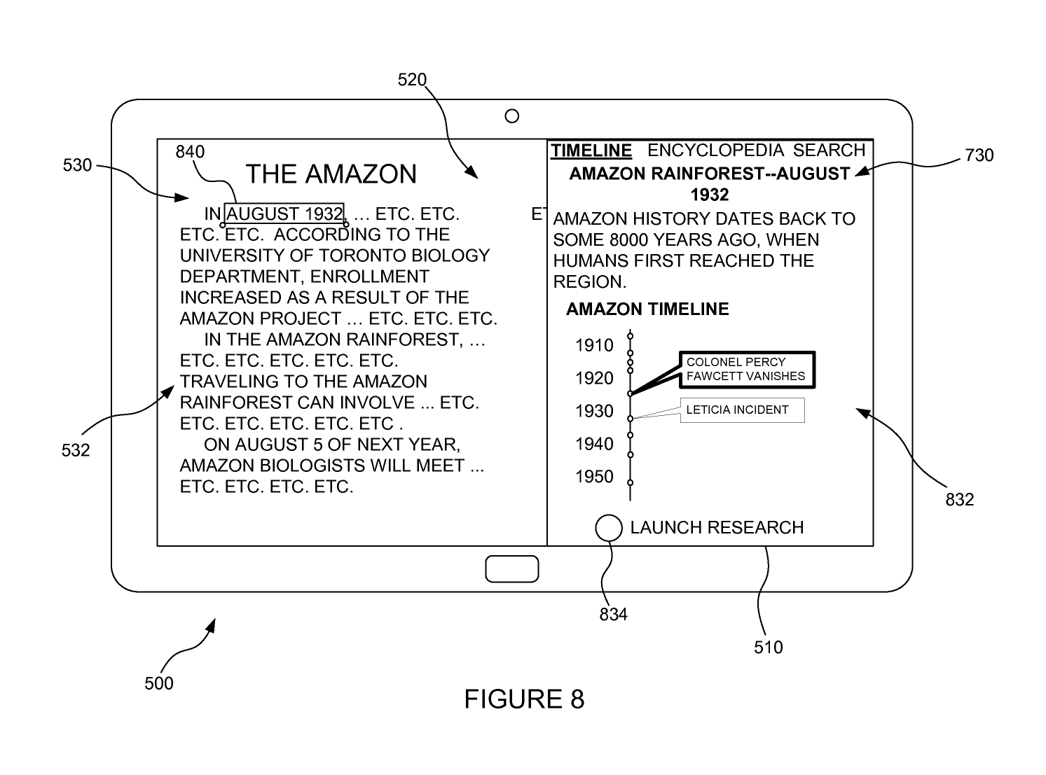

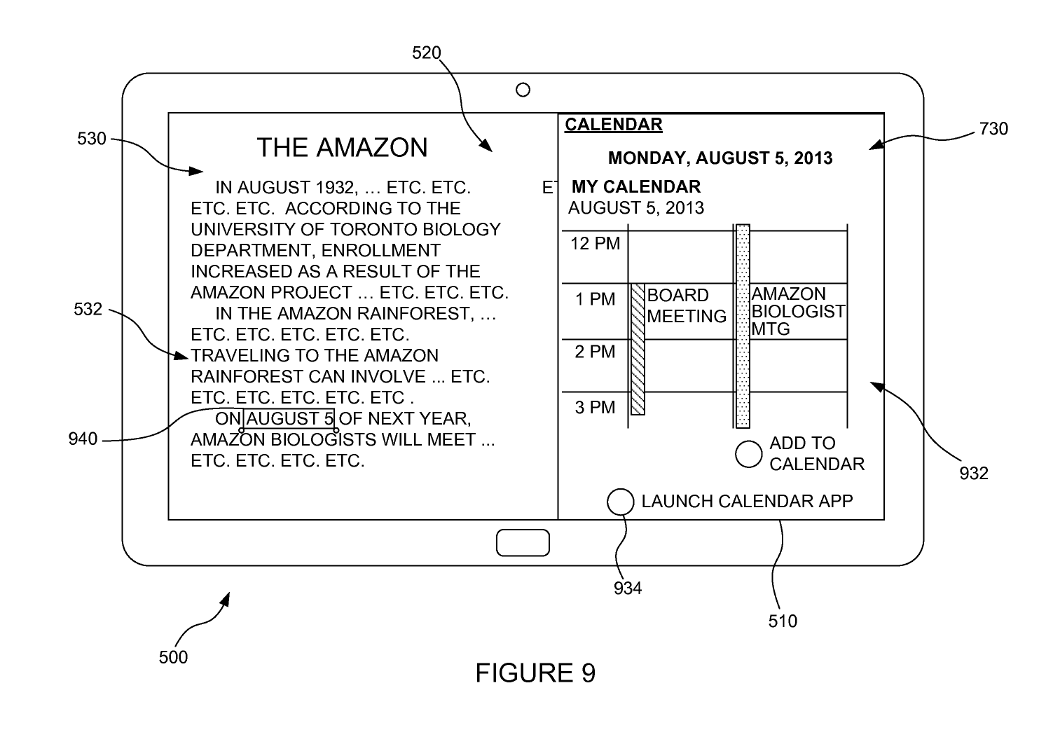

Referring now to FIGS. 8-9, some examples of displaying information according to selected entity type will be discussed. For example, as illustrated in FIG. 9, a user selection (840) of “August 1932” can be made, and entity recognition and disambiguation can analyze the selection and text around the selection to determine that the type of entity is a historic date, and that the historic date relates to the Amazon rainforest. Accordingly, the device (500) can retrieve information specific to this type of entity (historic date), and can display one or more representations (832) of the information in a manner that is specific to the type of entity. As illustrated, the secondary display can display one or more representations (832) that can include text about the history of the Amazon rainforest, as well as a timeline for the Amazon rainforest that encompasses the historic date indicated. The timeline can include indicators that can be selected to provide more information on events on the timeline, such as in the form of callouts. For example, as illustrated in FIG. 8, the timeline shows a callout for “COLONEL PERCY FAWCETT VANISHES” for the year 1925 and a callout for “LETICIA INCIDENT” for the year 1932. Such a callout could be selected for additional research by selecting the callout, and possibly by providing additional input such as by selecting a “LAUNCH RESEARCH” control (834). As an example, this callout selection could result in the device (500) retrieving and displaying Web search results or an encyclopedia article on the subject of the callout.

Referring now to FIG. 9, another example will be discussed. In this example, user input can identify “AUGUST 5” as a selection (940) for context-sensitive information display. Entity recognition and disambiguation can analyze the selection and text around the selection to determine that the type of entity is a current date (which may include future and recent past dates), that the text August 5 refers to August 5 of next year (which would be Aug. 5, 2013, for example, if the current date were in the fall of 2012), and that the date refers to the date of an Amazon biologist meeting. For example, this can be done using entity recognition, which can identify that August 5 is a date, and disambiguation, which can result in the selection of an entity for Aug. 5, 2013 and a label for Amazon Biologist Meeting, which can be extracted from the text following the August 5 selection (940).

Using this information, the device (500) can display one or more representations (932), which can include a representation of the user's calendar for Aug. 5, 2013. For example, the information for the calendar can be retrieved from a calendar application using an application programming interface, or by making a request to a calendar Web service where the user's calendar information is stored. Accordingly, a different calendar can be requested and displayed if different users select the same text in the same document because it is the calendar with the user's personal calendar information. For example, the active user profile can be detected, and the pertinent calendar for that user profile can be requested and displayed when text is selected with that user profile being active (e.g., when logged in with that profile's credentials at the time of the selection). The calendar can include a proposed calendar item for the Amazon Biologist Meeting, and user input can be provided to actually add the proposed calendar item to the user's calendar. Also, a control (934) can be selected to launch a calendar application with the user's calendar.

Of course, other different types of information retrieval (e.g., from different data sources, retrievals of different types of information, etc.) and/or displays (displaying in different formats or displaying different types of information) may be used for other different types of entities, and these are only given as examples. For example, for one type of entity, an automated data visualization such as a chart may be displayed. Such automated data visualization will be discussed below.

C. Automated Data Visualization about Selected Text

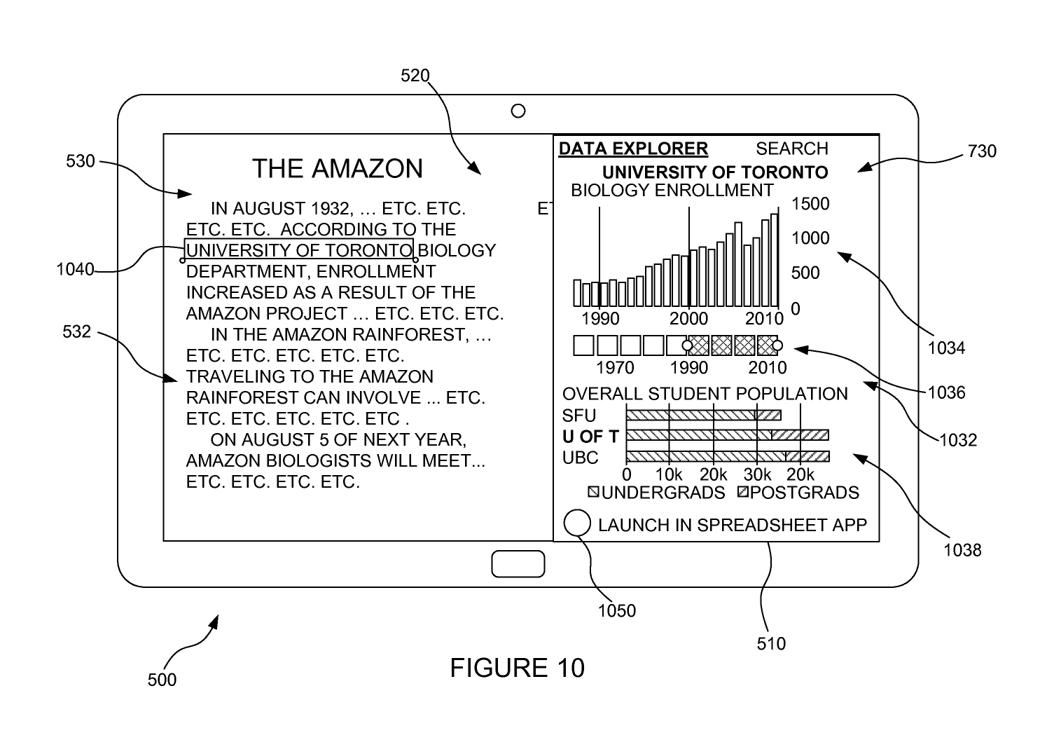

Referring now to FIG. 10, automated data visualization about selected text will be discussed. In the example, a selection (1040) is made of “UNIVERSITY OF TORONTO”. Entity recognition and disambiguation can determine that the meaning of the selection (1040) refers to enrollment in the biology department at the University of Toronto.

In response to the selection (1040), a dataset of enrollment statistics can be retrieved. All or a portion of that dataset can be identified as relating to enrollment of the biology department at the University of Toronto. For example, the dataset may include a table that has rows with numbers indicating enrollment in different departments (as shown in different columns) for the University of Toronto. The column for the biology department can be matched to the disambiguated entity (which can indicate enrollment in the biology department). Another column of the data may indicate the year for the corresponding enrollment data. Using pattern matching techniques, the dataset can be parsed and analyzed to identify this data, and to determine that a column chart is the best type of chart to show this type of data that corresponds to historic dates. Also, the dates from the dataset can be used to construct the labels along the bottom of the column chart. Accordingly, displayed representation(s) (1032) can include a constructed column chart (1034). For example, the selection of the chart type and the construction of the column chart can be performed in response to the selection (1032).

Also, the column chart (1034) in the representation(s) (1032) can be shown with a control bar (1036) below the chart (1034), which can allow a user to scroll through different date range windows by providing user input. The chart(1034) and other displayed charts may also include other interactive features, such as displaying an enrollment number from the dataset for a column on the chart if the column is selected by user input.

Also in response to the selection (1040), a second dataset of enrollment statistics can be retrieved. All or a portion of that dataset can be identified as relating to enrollment at the University of Toronto. For example, that dataset may include a table that has rows with numbers indicating graduate and undergraduate enrollment in different universities (in two columns), with one row being for the University of Toronto. The dataset could also include another column with a label (the abbreviation for the university name) for each university. Alternatively, such information may be included in the same dataset that was retrieved for the column chart (1034). This information may be matched to the disambiguated entity (which can indicate enrollment in the biology department of the University of Toronto, as discussed above). Using pattern matching techniques, the dataset can be parsed and analyzed to identify this data, and to determine that a dual bar chart is the best type of chart to show this type of data that corresponds to undergraduate and graduate enrollment for each university. Also, the labels for the university name abbreviations can be used to construct labels for each dual bar, and column headers indicating “UNDERGRADS” and “POSTGRADS” can be used as labels for the different portions of the dual bars on the dual bar chart. Accordingly, displayed representation(s) (1032) can include a constructed bar chart (1038). For example, the selection of the chart type and the construction of the bar chart can be performed in response to the selection (1040).

Also, the representation(s) (1032) can include a control (1050) that can be selected to launch a spreadsheet application with the displayed charts (1034 and 1038) and/or the underlying data from the dataset(s). In that situation, the spreadsheet could include the entire dataset(s), or only a portion of each dataset that is represented by the displayed chart.

The representation(s) (1032) could include a single chart or more than two charts. Also, if other types of data were present in a retrieved dataset, then a different type of chart may be selected by invoking rules and matching patterns for different types of charts. For example, if the dataset indicated percentages of students enrolled in each of the colleges in the University of Toronto, then those percentages may be shown in a pie chart. As another example, the dataset may represent an organizational structure, and in that case, an organizational chart may be selected and displayed.

### V. Context-Sensitive Information Display Techniques

Several context-sensitive information display techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable storage media may have computer-executable instructions embodied thereon that, when executed by at least one processor, cause at least one processor to perform the technique. The techniques discussed below may be performed at least in part by hardware logic.

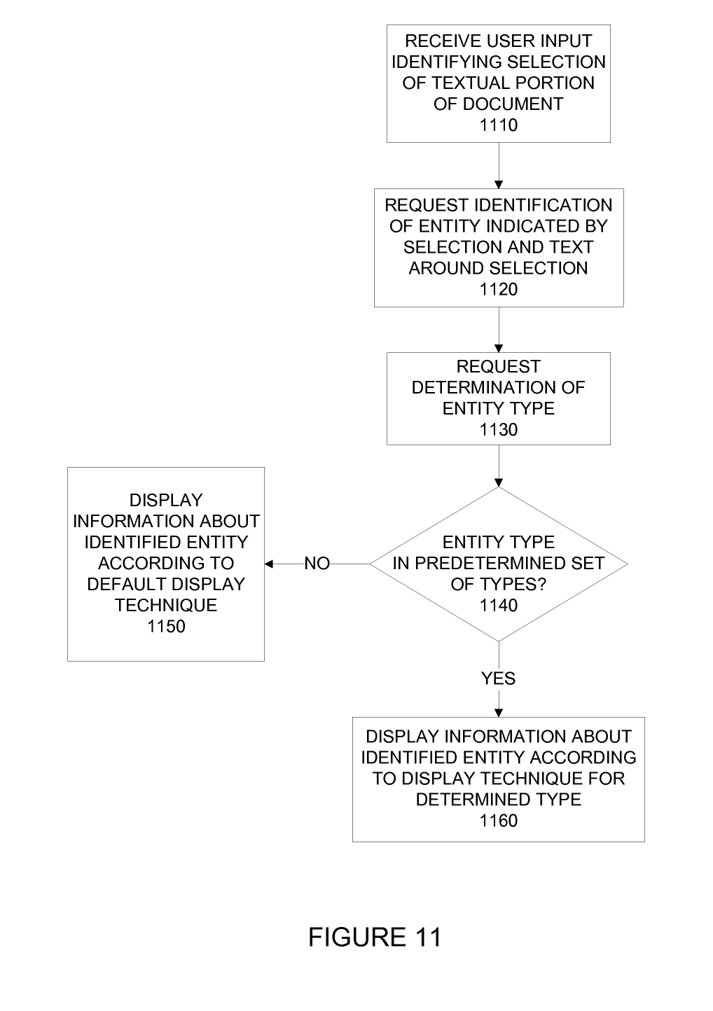

Referring to FIG. 11, a context-sensitive information display technique will be described. The technique can include receiving (1110) user input identifying a selection of a textual portion of a document being displayed in a computer display region. The technique can also include automatically requesting (1120) identification of an entity indicated by the selection and text around the selection. The technique can also include automatically requesting (1130) a determination of whether the identified entity is an entity type in a predetermined set of entity types, with each entity type in the set corresponding to a display technique for displaying information about that entity type. The display technique for each entity type can be different and can include displaying one or more user interface items specific to the entity type. If the identified entity is determined (1140) to be an entity type of the types in the predetermined set of entity types, then the technique can include displaying (1160) information about the identified entity according to the display technique for the determined entity type. Additionally, if it is determined (1140) that the identified entity is not one of the types in the predetermined set of entity types, then information about the identified entity can be displayed (1150) according to a default display technique (e.g., this displaying (1150) can include displaying general formatted data if sufficient information can be obtained to produce such formatted data or displaying (1150) can include displaying general Web search results after submitting context-sensitive search terms to a search engine using information from the entity identification and disambiguation, while a type specific display (1160) can include a more specific retrieval and/or display of information, such as those illustrated in the figures and discussed above).

The technique of FIG. 11 may further include the requested determination of whether the identified entity is an entity type in the predetermined set of entity types. The determination of whether the identified entity is an entity type in the predetermined set of entity types can include automatically disambiguating an identified meaning of the identified entity from among multiple possible meanings of the identified entity. Automatically disambiguating can be done using text around the selection.

The display technique for the determined entity type can include retrieving the information about the identified entity according to the display technique for the determined entity type, with retrieving information being done in a manner that is specific to the determined entity type. Also, the display technique for the determined entity type can include retrieving a dataset about the identified entity, automatically generating a visualization (e.g., a chart such as an interactive chart) representing the dataset (i.e., representing at least a portion of the dataset), and displaying the visualization.

The display technique for the determined entity type can include surfacing a type of interactive user interface control that is not surfaced in display techniques for one or more other entity types in the predetermined set of entity types. The determined entity type may be any of various different types, such as an entity type selected from a group consisting of general dates, current dates, historic dates, physical addresses, email addresses, telephone numbers, business names, geographical locations, items for sale, names of individual persons, more specific categories of one of the foregoing, and combinations thereof. For example, the identified entity may be a date, the determined entity type may include current dates, and the display technique for the determined entity type can include surfacing a user calendar that includes the determined date. As another example, the identified entity may be a name of an item for sale, the determined entity type can include items for sale, and the display technique for the determined entity type can include a control that can be selected to lead to purchasing the item for sale.

The technique of FIG. 11 and/or other techniques discussed herein may be performed at least in part by hardware logic.

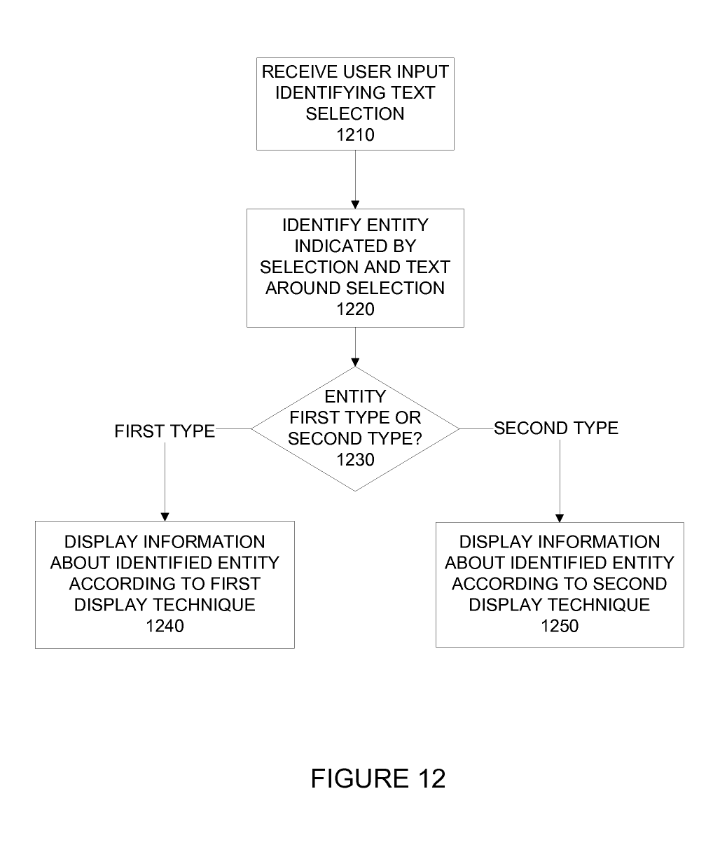

Referring to FIG. 12, another context-sensitive information display technique will be discussed. The technique can include receiving (1210) user input identifying a selection of text displayed in a computer display region. The technique can also include automatically identifying (1220) an entity indicated by the selection and text around the selection, as well as automatically determining (1230) whether the identified entity is the first entity type in a predetermined set of entity types and whether the identified entity is a second entity type in the predetermined set of entity types. If the identified entity is determined (1230) to be the first entity type, then the technique can include displaying (1240) information about the identified entity according to a first display technique that is specific to the first entity type. If the identified entity is determined (1230) to be the second entity type, then the technique can include displaying (1250) information about the identified entity according to a second display technique that is specific to the second entity type. The second display technique can be different from the first display technique. Identifying (1220) the entity and determining (1230) whether the entity is the first or second entity type can be done in response to receiving (1210) the user input.

The technique may include automatically determining (1230) an entity type of the identified entity, which can include automatically disambiguating an identified meaning of the identified entity from among multiple possible meanings of the identified entity, determining whether the identified entity is the first entity type, and determining whether the identified entity is the second entity type. Automatically disambiguating can be done using text around the selection.

The first display technique can include retrieving the information about the identified entity according to the first display technique. The second display technique can include retrieving the information about the identified entity according to the second display technique. The first display technique can include retrieving information differently than in the second display technique. The first display technique can include displaying a type of interactive user interface control that is not displayed in the second display technique. Likewise, the second display technique can include displaying a type of interactive user interface control that is not displayed in the first display technique.

The technique of FIG. 12 can further include performing one or more acts in response to user selection of the user interface control. For example, a portion of the display may change, an application may be launched with pertinent information being displayed in the application, etc.

The technique of FIG. 12 can include, for example, determining that the identified entity is the first entity type, where the first entity type is an address, and the display technique for the first entity type can include displaying a map that represents a geographic area including the address. A current location of a user's device (e.g., the client computing environment) could help determine what level of granularity is displayed for the map. For instance, if it is determined that the user's device is currently in Seattle, Wash. and the selection is an address for a location in Seattle, a detailed street map can be displayed. If it is determined that the user's device is in Seattle, and the selection is an address for a location in Anchorage, Ak., a map showing the entire state of Alaska may be displayed. Or, a map may be shown that displays the current location of the device, and the location indicated by the selection. Also, the map may be interactive so that, for instance, user input can be provided to zoom in or out for more or less granularity, or to map directions from the selected location to the current location of the device.

As another example, the technique can include determining that the identified entity is the first entity type, the first entity type being a telephone number, and the display technique for the first entity type can include displaying a control that can be selected to call the telephone number. If the system has access to a database of telephone numbers, the telephone number may be matched to a profile in the database, and this may result in being able to provide and display information on whose telephone number is selected (listing the person's name, picture, and/or other contact information, etc. in addition to the telephone number). As another example, it can be determined that the identified entity is the first entity type, where the first entity type is a business name, and the display technique for the first entity type can include displaying a map that includes a representation of one or more physical addresses for a business represented by the business name and displaying one or more user reviews of the business represented by the business name.

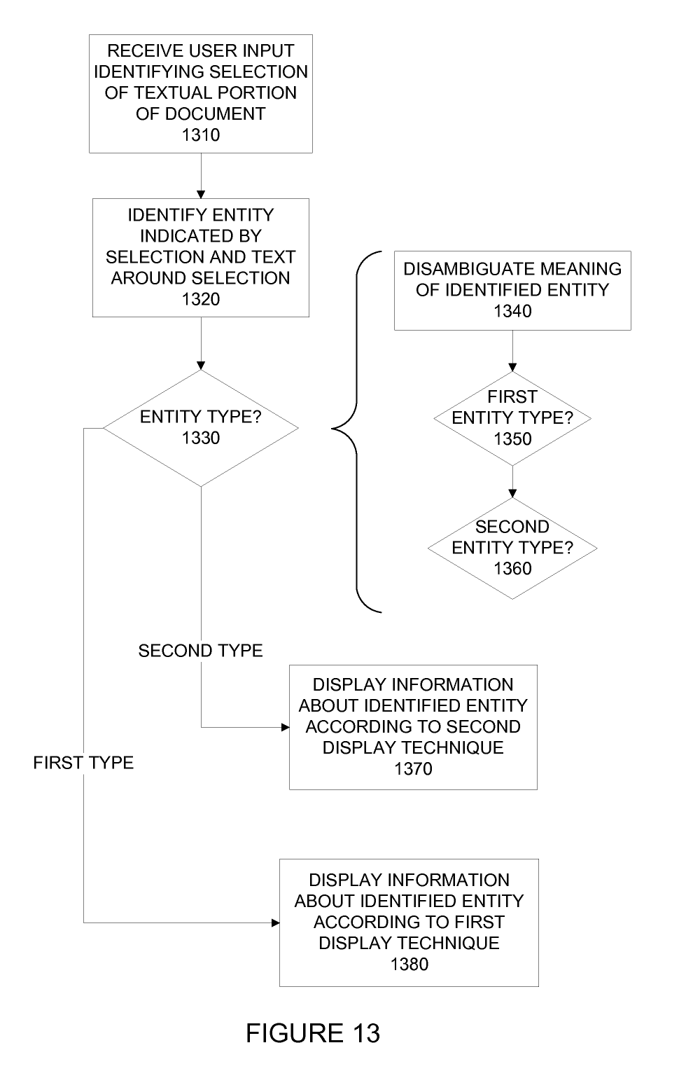

Referring to FIG. 13, yet another context-sensitive information display technique will be discussed. The technique can include receiving (1310) user input identifying a selection of a textual portion of a document being displayed in a computer display region of a user interface for a document display computer application. The technique of FIG. 13 can also include automatically identifying (1320) an entity indicated by the selection and text around the selection in response to receiving the user input. Also in response to receiving the user input, the technique can include automatically determining (1330) an entity type of the identified entity. This determination (1330) can include automatically disambiguating (1340) an identified meaning of the identified entity from among multiple possible meanings of the identified entity. Disambiguating (1340) can be done using text around the selection in the document. The determination (1330) can also include determining(1350) whether the identified entity is a first entity type in a predetermined set of entity types, and determining (1360) whether the identified entity is a second entity type in a predetermined set of entity types. If the identified entity is determined (1330) to be the first entity type, then the technique can include responding to receiving the user input by displaying (1380) information about the identified entity according to a first display technique that is specific to the first entity type. The first display technique can include displaying a type of user interface control that is not displayed in a second display technique. If the identified entity is determined to be a second entity type, then the technique can include responding to receiving the user input by displaying (1370) the information about the identified entity according to the second display technique that is specific to the second entity type. The second display technique can be different from the first display technique. The second display technique may include retrieving the information about the identified entity according to the second display technique. The first display technique may include displaying a type of interactive user interface control that is not displayed in the first display technique.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer-implemented method, comprising:
receiving user input identifying a selection of a textual portion of a document being displayed in a computer display region;
automatically requesting identification of an entity indicated by the selection and text around the selection;
automatically requesting a determination of whether the identified entity is an entity type in a predetermined set of entity types, each entity type in the predetermined set of entity types corresponding to a display technique for displaying information about that entity type, the display technique for each entity type being different and comprising displaying one or more user interface items specific to the entity type; and
if the identified entity is determined to be an entity type of the types in the predetermined set of entity types, then responding to the user input by automatically displaying the information about the identified entity according to the display technique for the determined entity type.

2. The method of claim 1, wherein the method further comprises the requested determination of whether the identified entity is an entity type in the predetermined set of entity types, and wherein the determination of whether the identified entity is an entity type in the predetermined set of entity types comprises automatically disambiguating an identified meaning of the identified entity from among multiple possible meanings of the identified entity, the automatically disambiguating being done using text around the selection.

3. The method of claim 1, wherein the display technique for the determined entity type comprises retrieving a dataset about the identified entity, automatically generating a visualization representing the dataset, and displaying the visualization.

4. The method of claim 1, wherein the display technique for the determined entity type comprises retrieving the information about the identified entity according to the display technique for the determined entity type, retrieving the information being done in a manner that is specific to the determined entity type.

5. The method of claim 1, wherein the display technique for the determined entity type comprises surfacing a type of interactive user interface control that is not surfaced in display techniques for one or more other entity types in the predetermined set of entity types.

6. The method of claim 1, wherein the determined entity type is selected from a group consisting of general dates, current dates, historic dates, physical addresses, email addresses, telephone numbers, business names, geographical locations, items for sale, names of individual persons, more specific categories of one of the foregoing, and combinations thereof.

7. The method of claim 6, wherein the identified entity is a date, the determined entity type comprises current dates, and the display technique for the determined entity type comprises surfacing a user calendar that includes the determined date.

8. The method of claim 6, wherein the identified entity is a name of an item for sale, the determined entity type is comprises items for sale, and the display technique for the determined entity type comprises a control that can be selected to lead to purchasing the item for sale.

9. The method of claim 1, wherein the method is performed at least in part by hardware logic.

10. A computer system comprising:
at least one processor; and
memory comprising instructions stored thereon that when executed by at least one processor cause at least one processor to perform acts comprising:
receiving user input identifying a selection of text displayed in a computer display region;
automatically identifying an entity indicated by the selection and text around the selection;
automatically determining whether the identified entity is a first entity type in a predetermined set of entity types;
automatically determining whether the identified entity is a second entity type in the predetermined set of entity types;
if the identified entity is determined to be the first entity type, then displaying information about the identified entity according to a first display technique that is specific to the first entity type; and
if the identified entity is determined to be the second entity type, then displaying the information about the identified entity according to a second display technique that is specific to the second entity type, the second display technique being different from the first display technique.

11. The computer system of claim 10, wherein the acts comprise automatically determining an entity type of the identified entity, automatically determining an entity type comprising:
automatically disambiguating an identified meaning of the identified entity from among multiple possible meanings of the identified entity;
determining whether the identified entity is the first entity type; and
determining whether the identified entity is the second entity type.

12. The computer system of claim 11, wherein automatically disambiguating is done using text around the selection.

13. The computer system of claim 10, wherein the first display technique comprises retrieving the information about the identified entity according to the first display technique, the second display technique comprises retrieving the information about the identified entity according to the second display technique, and the first display technique comprises retrieving information differently than in the second display technique.

14. The computer system of claim 10, wherein the first display technique comprises displaying a type of interactive user interface control that is not displayed in the second display technique.

15. The computer system of claim 14, wherein the acts further comprise performing one or more acts in response to user selection of the user interface control.

16. The computer system of claim 14, wherein the second display technique comprises displaying a type of interactive user interface control that is not displayed in the first display technique.

17. The computer system of claim 10, wherein the acts comprise determining that the identified entity is the first entity type, the first entity type is an address, and the display technique for the first entity type comprises displaying a map that represents a geographic area including the address.

18. The computer system of claim 10, wherein the acts comprise determining that the identified entity is the first entity type, the first entity type is a telephone number, and the display technique for the first entity type comprises displaying a control that can be selected to call the telephone number.

19. The computer system of claim 10, wherein the acts comprise determining that the identified entity is the first entity type, the first entity type is a business name, and the display technique for the first entity type comprises displaying a map that includes a representation of one or more physical addresses for a business represented by the business name and displaying one or more user reviews of the business represented by the business name.

20. One or more computer-readable storage media having computer-executable instructions embodied thereon that, when executed by at least one processor, cause at least one processor to perform acts comprising:
receiving user input identifying a selection of a textual portion of a document being displayed in a computer display region of a user interface for a document display computer application;
in response to receiving the user input, automatically identifying an entity indicated by the selection and text around the selection;
in response to receiving the user input, automatically determining an entity type of the identified entity, automatically determining an entity type comprising:
automatically disambiguating an identified meaning of the identified entity from among multiple possible meanings of the identified entity, automatically disambiguating being done using text around the selection in the document;
determining whether the identified entity is a first entity type in a predetermined set of entity types; and
automatically determining whether the identified entity is a second entity type in a predetermined set of entity types;
if the identified entity is determined to be a first entity type, then responding to receiving the user input by displaying information about the identified entity according to a first display technique that is specific to the first entity type, the first display technique comprising displaying a type of user interface control that is not displayed in a second display technique; and
if the identified entity is determined to be a second entity type, then responding to receiving the user input by displaying the information about the identified entity according to the second display technique that is specific to the second entity type, the second display technique being different from the first display technique, the second display technique comprising retrieving the information about the identified entity according to the second display technique, and the first display technique comprises retrieving information differently than in the second display technique, the second display technique comprising displaying a type of interactive user interface control that is not displayed in the first display technique.
